(19) United States
(12) Patent Application Publication
(10) Pub. No.: US 2002/0185560 A1
(43) Pub. Date: Dec. 12, 2002

(54) Adjustable refiner plate pattern

(76) Inventor: Ola M. Johansson, Brookfield, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 09/876,406

(22) Filed: Jun. 7, 2001

(51) Int. Cl. B02C 7/12

(52) U.S. Cl. 241/298

(57) ABSTRACT

A refiner plate pattern that is adjustable for casting a rotary disk refiner plate. The refiner plate pattern has a portion of its refining surface that is adjustable relative to some other part. In one preferred embodiment, the refiner plate pattern has a part of its refining surface that can be angularly adjusted relative to some other part of the refining surface. A method of casting a refiner plate segment from the pattern is also provided.

### FIELD OF THE INVENTION

The present invention relates to a pattern for a refiner plate segment for a disk refiner and more particularly to a refiner plate pattern that is adjustable.

### BACKGROUND OF THE INVENTION

Many products we use everyday are made from fibers. Examples of just a few of these products include paper, personal hygiene products, diapers, plates, containers, and packaging. Making products from wood fiber, fabric fiber, and the like, involves breaking solid matter into fibrous matter. This also involves processing the fibrous matter into individual fibers that become fibrillated or frayed so they more tightly mesh with each other to form a finished fiber product that is desirably strong, tough, and resilient.

In fiber product manufacturing, refiners are devices used to process the fibrous matter, such as wood chips, fabric, and other types of pulp, into fibers and to further fibrillate existing fibers. The fibrous matter is transported in liquid stock to each refiner using a feed screw driven by a motor.

Each refiner has at least one pair of annular refiner plates that face each other. During refining, fibrous matter in the stock to be refined is introduced into a gap between the plates that usually is quite small. Relative rotation between the plates during operation fibrillates fibers, e.g., grinds or mashes them, in the stock as the stock passes radially outwardly between the plate.

One example of a refiner that is a disk refiner is shown and disclosed in U.S. Pat. No. 5,425,508. However, many different kinds of refiners are in use today. For example, there are counterrotating refiners, double disk or twin refiners, and conical disk refiners. Conical disk refiners are often referred to in the industry as CD refiners.

Each refiner plate has an arrangement of upraised bars that is usually selected for a particular refining application. Some arrangements of upraised bars are intended for high consistency refining or primary refining and others are intended for low consistency refining or secondary refining. Other arrangements of upraised bars for other applications are also available. Also, it is not uncommon to have certain arrangements of upraised bars that are used for some makes of refiners and other arrangements of upraised bars that are used for other makes of refiners. Thousands of arrangements of upraised bars are available and many appear to be at least somewhat similar as there can be only relatively small geometrical differences between them.

Despite the similarity between various arrangements of upraised bars, there can be significant differences in performance between arrangements of upraised bars that appear quite similar. In fact, the same arrangement of upraised bars can perform quite differently in two different fiber processing mills, two different refiners, or in two different kinds of refiners.

Thus, it is clear that the process of selecting a particular arrangement of upraised bars for a particular refining application in a particular fiber processing mill is as much of an art form as it is science. It is not uncommon for refiner plates having a particular arrangement of upraised bars to be tried on an experimental basis for a particular set of refining conditions to see how they work. If the plate works acceptably, that arrangement of upraised bars will be stocked by the mill for that particular refining application. This trial and error process can be repeated many, many times before a particular refiner plate arrangement of upraised bars is selected for the particular refining application.

In addition, the arrangement of upraised bars used in a refiner plate can dramatically impact the cost of refining. The competitiveness of the refining process is being threatened by escalating energy costs. This is especially true in North America since the electrical energy market has been de-regulated, and a new price level for electrical energy has been set. Because of the rapid increase in cost, the urgency for improved utilization of the electrical energy is increasing as well. An optimized arrangement of upraised bars can make a dramatic decrease in the energy cost of refining.

What is needed is an adjustable refiner plate pattern for making a refiner plate segment for a refiner plate. What is also needed is a refiner plate segment for a refiner plate that has a arrangement of refiner bars that is made from an adjustable refiner plate pattern. What is also needed is a refiner plate made from plurality of the cast refiner plate segments. What is also needed is a method of producing refiner plate segments with an adjustable refiner plate pattern.

### SUMMARY OF THE INVENTION

The invention is generally directed toward an adjustable refiner plate pattern for making a refiner plate segment and an improved refiner plate segment for a refiner plate, the refiner plate being made from refiner plate segments that are formed from the adjustable refiner plate pattern. The invention is also generally directed to a refiner plate for a disk refiner, the refiner plate being formed from a plurality of the refiner plate segments that are formed from the adjustable refiner plate pattern. The invention is also generally directed toward a method of making a refiner plate segment from the adjustable refiner plate pattern.

The refiner plate pattern can be used to make refiner plate disc segments that can form a refiner disk. The configuration of the refiner plate pattern is substantially the same configuration as that of the refiner plate disc segment made therefrom. The refiner plate pattern can be used to make refiner plate segments using any process where the refiner plate pattern is used to make a mold cavity from which the refiner plate segment is constructed. In a preferred method, material is poured into the mold cavity to form a casting of unitary construction. The casting has substantially the same configuration as the refiner plate pattern with the arrangement of upraised bars in the plate segment being determined by the adjustable arrangement of upraised bars in the refiner plate pattern.

The refiner plate pattern has at least a portion of its refining surface that can be adjusted. In another preferred embodiment, the refiner plate pattern has at least a portion of its refining surface that is adjustable by being movable relative to a radial line of the refiner plate pattern or some other portion of its refining surface, such as by being rotatable.

One refiner plate pattern has a portion of its refining surface that can be adjusted relative to some other portion of its refining surface. In one preferred embodiment, the refiner plate pattern has a pattern insert in its refining surface that is comprised of a plurality of spaced apart refiner bars forming a refining surface of the refiner plate pattern. The orientation of the arrangement of refiner bars of the pattern insert can be changed relative to other refiner bars of the refining surface of the rest of the refiner plate pattern. In one preferred embodiment, the pattern insert is circular, has a plurality of pairs of refiner bars, can have one or more breaker bars, and can have one or more dams. In one preferred embodiment, the pattern insert is received in a pocket in the refiner plate pattern.

If desired, the pattern insert in the refiner plate pattern can be indexable. Where indexable, the pattern insert can have a shape that preferably is symmetric such that its refining surface is not circular. For example, the pattern insert can be square, triangular, pentagonal, hexagonal, or have another symmetric shape. If desired, either the refiner plate pattern or the pattern insert can be equipped with one or more detents that each can be received in complementary detent-receiving notches. For example, in one preferred pattern insert embodiment, the pattern insert is equipped with at least one detent that is received in one of a plurality of detent-receiving notches in the refiner disc. In another preferred pattern insert embodiment, the pattern insert has a plurality of spaced apart detents and the refiner plate pattern has a plurality of spaced apart detent-receiving notches. If desired, the pattern insert can have detents equiangularly spaced about the periphery of the pattern insert, with the spacing between adjacent detents chosen to provide a minimum indexing angle.

In one preferred embodiment, a refiner plate is made from refiner plate segments formed from the refiner plate pattern. The refiner plate pattern includes breaker bars on the pattern insert and no breaker bars on the refiner plate pattern. The resulting refiner plate segment formed from the refiner plate pattern includes a portion of its refining surface disposed adjacent its inner periphery angularly offset relative to another radially outwardly portion of its refining surface such that the angle of the refiner bars accelerates fibers adjacent the inner periphery.

Objects, features, and advantages of the present invention include at least one of the following: a refiner plate pattern that can be adjusted to tailor the performance characteristics of a refiner plate segment produced from the refiner plate pattern for the intended refining application; that can be adjusted to change the performance characteristics of a refiner plate segment cast from the refiner plate pattern to tune the refiner plate segment for optimum performance; that increases quality; that reduces energy used in a refiner incorporating refiner plates formed from refiner plate segments cast from the refiner plate pattern; that maintains a more uniform gap between opposed pairs of refiner plates made with the refiner plate segment cast from the refiner plate pattern;; that produces a refiner plate segment that is robust, that is tough; that produces a refiner plate that is capable of operating on many different kinds of disk refiners; that is simple, flexible, reliable, and long lasting; and that is of economical manufacture and is easy to assemble, install, and use.

Other objects, features, and advantages of the present invention will become apparent to those skilled in the art from the detailed description and the accompanying drawings. It should be understood, however, that the detailed description and accompanying drawings, while indicating at least one preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout and in which:

FIG. 1 is a fragmentary cross sectional view of a refiner equipped with a refiner plate or plate segment formed from an adjustable refiner plate pattern;

FIG. 2 is a perspective view of one preferred embodiment of the adjustable refiner plate pattern including two pattern insert;

FIG. 3 is a top plan view of another preferred embodiment of the refiner plate pattern including one pattern insert;

FIG. 4 is an enlarged perspective view of one of the adjustable pattern insert shown in FIGS. 2 and 3;

FIG. 5 is an exploded rear perspective view of the refiner plate pattern shown in FIG. 2;

FIG. 6 is a rear plan view of the refiner plate pattern shown in FIG. 3;

FIG. 7 is an exploded rear perspective view an embodiment of an indexable pattern insert and refiner plate pattern;

FIGS. 8-11 depict refiner plate patterns having pattern inserts of different shapes;

FIG. 12 is a side elevation view of a sand mold that can be used to make a refiner plate segment with a refiner plate pattern;

FIG. 13 is a cross-sectional view of a refiner plate segment casting formed in the sand mold shown in FIG. 12; and

FIG. 14 is a top plan view of a refiner plate formed from refiner plate segments formed from a refiner plate pattern.

### DETAILED DESCRIPTION OF THE INVENTION

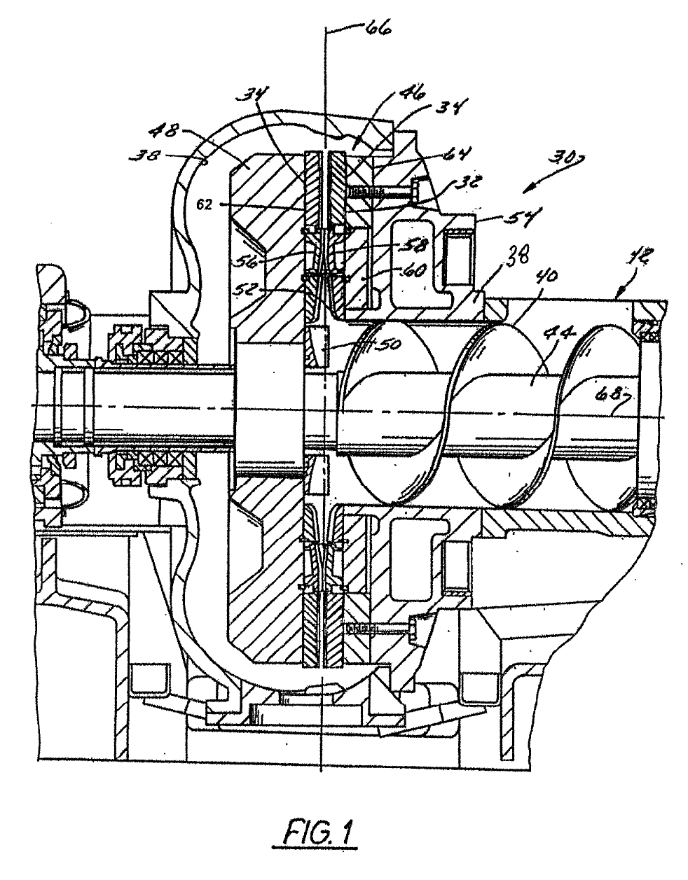

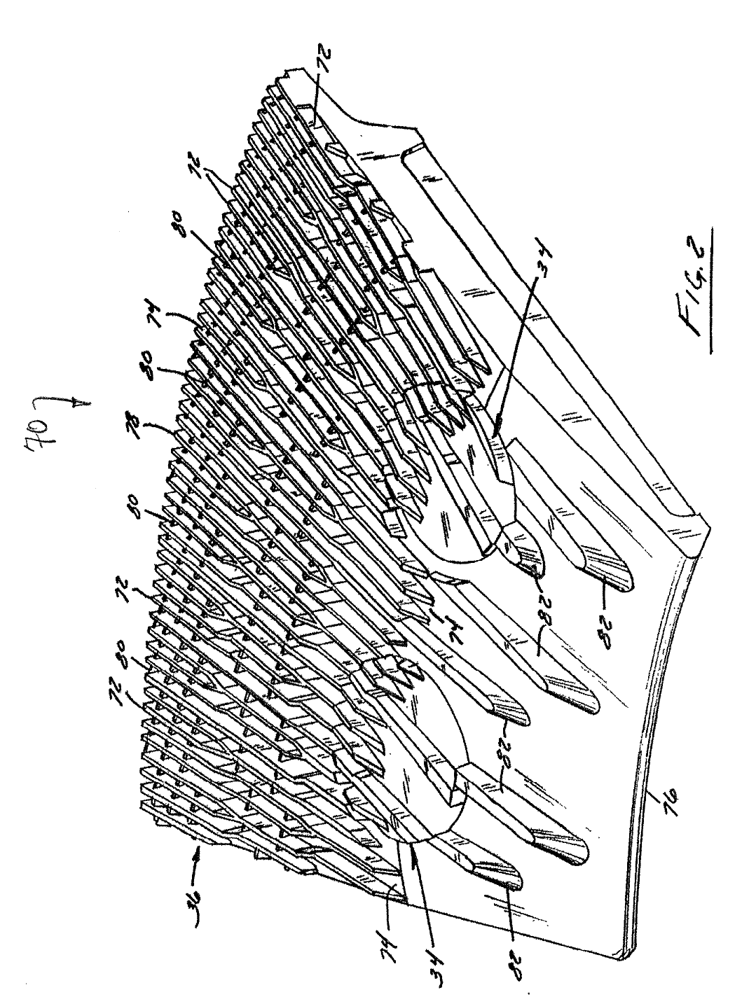

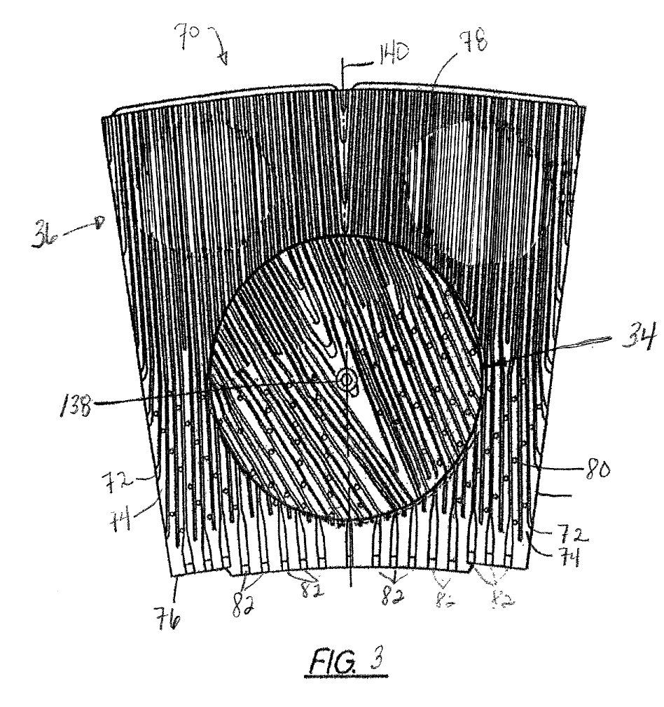

FIG. 1 illustrates a refiner 30 that has a preferred embodiment of a refiner plate comprised of refiner plate segments 370 formed from a refiner plate pattern 70 that can be equipped with a pattern insert 34 that forms part of its refining surface 36 as is shown in FIGS. 2 and 3. The pattern insert 34 can be rotated to change the arrangement of the upraised bars of the refining surface 36 or at least the orientation of at least a part of the arrangement of the upraised bars of the refining surface 36. After the pattern insert 34 is positioned in a desired orientation, it can be used to form a mold cavity 274 that can be used in any process to form refiner plate segment having a shape that is substantially complementary to that of the mold cavity 274. In a preferred embodiment, the mold cavity 274 is used to cast a refiner plate segment 370. The refiner plate segments thus will have an arrangement of refiner bars that includes those of the adjustable pattern insert on the refiner plate pattern. Therefore, a variety of refiner plate segments can be made with an infinite number of refiner bar arrangements. The refiner plate segments 370 can then be assembled to form a refiner plate 32 for a disk refiner 30.

An exemplary refiner 30 in which refiner plate segments 370 made according to the invention can be used is shown in FIG. 1. The refiner 30 can be a disc refiner of the type used in thermomechanical pulping, refiner-mechanical pulping, chemithermomechanical pulping, or another type of pulping, cellulose, or fiber refining application. The refiner 30 can be a counterrotating refiner, a double disk or twin refiner, or a conical disk refiner that is also known in the industry as a CD refiner.

The refiner 30 has a housing or casing 38 and an auger 40 mounted therein which helps urge a stock slurry of liquid and fiber introduced through a stock inlet 42 into the refiner 30. The auger 40 includes a shaft 44 that rotates during refiner operation to help supply stock to an arrangement of treating structure 46 within the housing 38. The shaft 44 is connected to a rotor 48 that carries an annular flinger nut 50, which is disposed generally in line with the auger 40. The flinger nut 50 directs the stock radially outwardly toward a plurality of opposed sets of breaker bar segments, both of which are indicated by reference numeral 52 in FIG. 1.

Each set of breaker bar segments 52 preferably is in the form of sectors of an annulus, which together form an encircling section of breaker bars. One set of breaker bar segments is fixed to the rotor 48. The other set of breaker bar segments is fixed to another portion of the refiner 30, such as a stationary mount 54, e.g., a stator, of the refiner or another rotor (not shown).

Stock flows radially outwardly from the breaker bar segments 52 to a radially outwardly positioned set of refiner plates or disks 56 and 58. Each refiner plate preferably is removably attached to a mounting surface. For example, one plate 56 is mounted to the rotor 48 and the other plate 58 is mounted to a mounting surface 60 that is carried by the stator 54.

The refiner 30 includes a second set of refiner plates 32 and 62 positioned radially outwardly of the first set of plates 56 and 58. Plate 32 is mounted to a mounting surface 64 that is carried by the stator 54, and plate 62 is mounted to the rotor 48. These plates 32 and 62 preferably are also removably mounted. Each pair of plates 56 and 58 and 32 and 62 of each set is spaced apart so as to define a relatively small gap therebetween that typically is between about 0.002 inches (0.05 mm) and about 0.200 inches (5.08 mm) defining a refining zone in that gap.

The first set of plates 56 and 58 is disposed generally parallel to a radially extending plane 66 between them that is shown in FIG. 1 as being generally perpendicular to an axis 68 of rotation of the auger 40. The second set of plates 32 and 62 can also be disposed generally parallel to this same plane 66. This plane 66 is depicted as passing through the refiner gap between each set of opposed plates. This plane 66 also passes through the space between each set of plates that defines a refining zone between them. Depending on the configuration and type of refiner, different sets of refiner plates can be oriented with their refining zones in different planes.

During operation, the rotor 48 and the plates 56 and 60 rotate about axis 68 causing relative rotation between them and plates 32 and 58. Typically, the rotor 48 is rotated between about 400 and about 3,000 revolutions per minute. During operation, fiber in the stock slurry is fibrillated as it passes between the plates 32, 56, 58, and 60 refining the fiber. After it passes between the plates, the stock slurry flows out an outlet in the refiner 30.

FIGS. 2 and 3 depict an adjustable refiner plate pattern 70 that can be used to form a segment 370 of refiner plate 32. The refiner plate pattern 70 shown in FIG. 2 includes two pattern inserts 34, whereas the refiner plate pattern 70 shown in FIG. 3 includes one pattern insert 34 that is rotatable relative to radial line 140. The refiner plate pattern 70 preferably is comprised of a plastic, a metal, an alloy, a ceramic, or another suitable material. Preferably, the material is a formable material, such that the material can be formed, such as by machining, to make the refiner plate pattern 70. The refiner plate pattern 70 can also be formed from more than one piece, with each piece being made from a different material, such as a plastic piece for the top half of the refiner plate pattern 70, and an aluminum piece for the bottom half of the refiner plate pattern 70.

The refiner plate pattern 70 has a plurality of pairs of spaced apart upraised bars 72 that define grooves or channels 74 therebetween. The bars 72 and grooves 74 define a refining surface 36 that generally extends from an outer diameter 78 toward an inner diameter 76 of the refiner plate pattern 70. The arrangement of bars 72 and grooves 74 shown in FIGS. 2 and 3 are exemplary arrangement of bars, as any arrangement of bars 72 and grooves 74 can be used. If desired, dams 80 of surface or subsurface construction can be disposed in one or more of the grooves 74. If desired, the refiner plate pattern 70 can have a plurality of spaced apart breaker bars 82 adjacent the inner diameter 76.

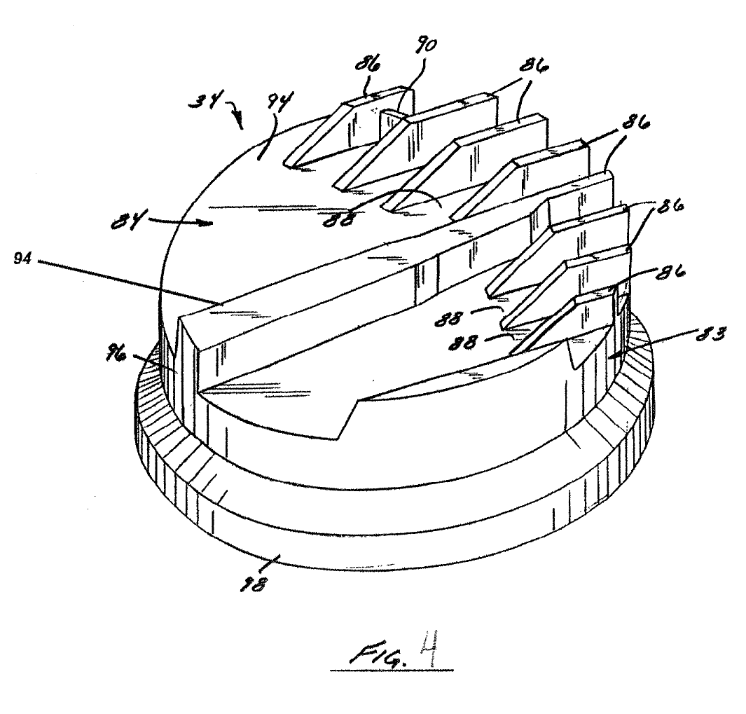

As is shown in more detail in FIG. 4, the pattern insert 34 includes a refining surface 84 and a base 83 that preferably has a portion 98 that is enlarged relative to the rest of the pattern insert 32. The refining surface 84 of the pattern insert 34 has a plurality of upraised bars 86 that are spaced apart so as to define grooves 88 therebetween. If desired, one or more dams 90 can be disposed in a groove 88 of a pattern insert 34. If desired, the pattern insert 34 can have one or more upraised breaker bars 94.

The preferred pattern insert 34 shown in FIG. 4 has only a portion of the refining surface 84 comprised of refiner bars 86. The remaining surface, including that which is located between adjacent bars 86 and 94, can be flat and substantially smooth. If equipped with breaker bars 94, the breaker bars 94 preferably are disposed generally adjacent the inner diameter 76 of the refiner plate pattern 70, such as is shown in FIGS. 2 and 3. If desired, the entire pattern insert 34 refining surface 84 can be substantially completely comprised of refiner bars 86, such as is depicted by the pattern insert 34 shown in FIG. 3.

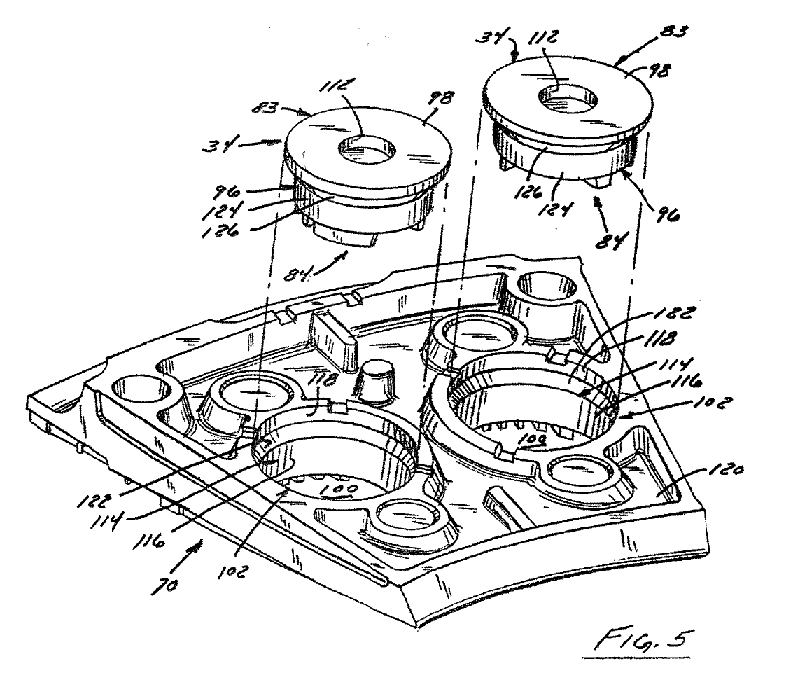

A preferred pattern insert assembly is depicted in FIG. 5. The pattern insert 34 is disposed in a pocket 102 in the refiner plate pattern 70 such that its refining surface 84 is exposed through a window 100 in the refining surface 36. The window 100 in the refiner plate segment 70 communicates with the pocket 102, and the pocket 102 preferably extends completely through the backside of the refiner plate pattern 70.

The window 100 in the segment refining surface 36 of the refiner plate pattern preferably has a shape that is complementary to the shape of the periphery of the refining surface 84 of the pattern insert 34. The pattern insert-receiving pocket 102 is defined by an interior sidewall 114. The sidewall 114 can diametrically narrow toward the window 100 such as for helping prevent displacement of the pattern insert 34. In the preferred embodiment shown in FIG. 5, the sidewall 114 has a first portion 116 that is substantially orthogonal to the segment refining surface 36 of the refiner plate pattern 70. The sidewall 114 has a second portion 118 adjacent the backside 120 of the refiner plate pattern 70. The second sidewall portion 118 includes a chamfer or inclined portion 122 that extends generally radially outwardly from the sidewall portion 116. Where the pocket 102 is circular, the second sidewall portion 118 comprises a counterbore or countersink for a pattern insert 34 that preferably also is circular.

The pattern insert 34 has a sidewall contour that is complementary to the sidewall contour of the pattern insert-receiving pocket 102 in the refiner plate pattern 70 as shown in the pattern insert 34 embodiment of FIG. 5. After the pattern insert 34 is received in the pocket 102, the angle of the refiner bars 86 of the pattern insert 34 is set relative to the angle of the refiner bars 72 of the refiner plate pattern 70. The pattern insert 34 is then anchored to the window 100. For example, in a preferred arrangement, the pattern insert 34 is placed into the window 100, and a keeper plate (not shown) is mounted over the pattern insert 34 and to the refiner plate pattern 70 to anchor the pattern insert 34 in place.

In a currently preferred embodiment, the refiner plate pattern is constructed and arranged such that the patterned surface 36 of the insert 34 is uninterrupted by any fastener or other component used to attach the insert to the remainder of the refiner plate pattern 70. For example, a fastener can extend from the backside of the pattern 70 into the insert 34 to attach the insert 34 to the refiner plate pattern 70. Teeth can be provided (not shown) that engage the insert and/or the backside of the pattern 70 to keep it from rotating once its desired angular position has been set.

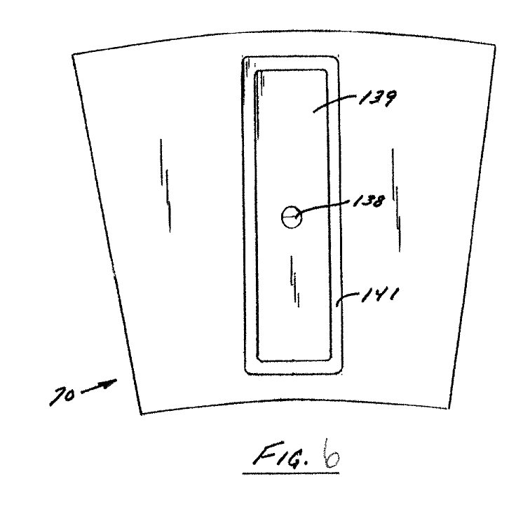

FIGS. 3 and 6 illustrate another preferred arrangement for retaining the pattern insert 34 in place. The arrangement includes fastener 138 that engages a plate or washer 139 disposed behind the refining surface. In this arrangement, the fastener 138 is a bolt that is received in a threaded bore in the plate 139. If desired, the plate 139 can be disposed in a pocket 141 in the rear of the refiner plate pattern 70. If desired, the fastener 138 can be threaded into a nut 143 (not shown).

In one preferred embodiment, the arrangement includes a washer 145 that is disposed between the pattern insert 34b and the plate 139. In a preferred embodiment, there is engagement between the washer 145 and the pattern insert 34b and engagement between the washer 145 and the plate 139 that prevents the pattern insert 34b from rotating during refiner operation. In one preferred embodiment, bosses in either the pattern insert 34b and/or the washer 145 are received in detents in the other one of the pattern insert 34b and/or the washer 145 to provide an interlock therebetween. Similarly, either the washer 145 and plate 139 or both of them can have bosses and detents to provide an interlock therebetween.

The angle of the bars 86 of the pattern insert 34 preferably is set before the mold cavity 274 is formed, as is described below. As a result of the construction of the preferred pattern insert 34 and the pattern insert-receiving pocket 102 in the refiner plate pattern 70, the angle of the bars 86 of the pattern insert 34 can be infinitely adjusted relative to the bars 72 of the refining surface 36 of the refiner plate pattern 70 in which the pattern insert 34 is disposed. Therefore, the angle of the bars 86 of the pattern insert 34 can be adjusted in degree increments of as little as 0.5 degrees. Preferably, in a typical refining application, the angle of the bars 86 of the pattern insert 34 will be substantially parallel to the segment bars 72 or disposed within ±30 degrees of the segment bars 72.

By being able to change the angle of some refiner bars 86 relative to other refiner bars 72, various parameters of the refining process can advantageously be controlled enabling them to be tuned and for refiner plates having various refiner bar arrangements to be made therefrom, such as by trial and error. For example, changing the angle of refiner bars 86 can be selectively done to increase or decrease the magnitude or amplitude of load swings that occur due to alternate pumping and holdback action that is understood in the art.

This can also be used in tuning the refiner 30 to change its natural frequency so that normally occurring vibration does not excite the refiner 30 into excessive vibration or resonance. To do so, the angle of the refiner bars 86 of the pattern insert 34 can be adjusted until the amplitude of vibration is reduced. In one preferred method of tuning, the angle of the pattern insert 34 is adjusted until vibration is at a minimum. Other refiner parameters can also be tuned in a similar or the same manner.

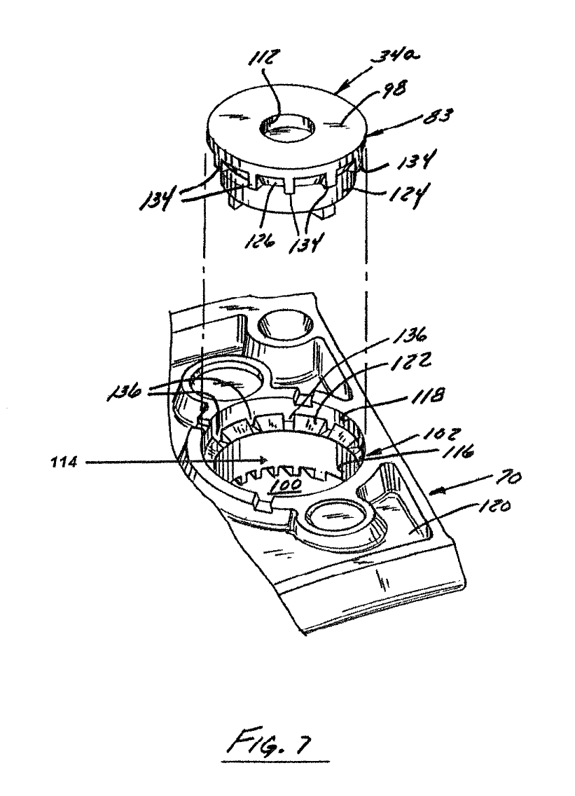

FIG. 7 illustrates another preferred pattern insert 34a embodiment. The head 126 of the base 83 of the pattern insert 34a has at least one detent 134 that can be received in at least two angularly spaced apart notches 136 that each preferably have a shape that at least partially conforms to the shape of detent 134. Each of the detent-receiving notches 136 is disposed in the bevel surface 122 of pattern insert-receiving hole 102. The pattern insert 34a preferably also has at least two detents 134 and at least five detents are shown in FIG. 7. If desired, the location of the detents 134 and notches 136 can be flipped with the detents 134 extending outwardly from pocket sidewall 114 and the pattern insert 34a having the notches 136.

For example, where it is desired to provide angular adjustment of the pattern insert 34a in increments often degrees, there are thirty-six notches 136. For example, where it is desired to provide angular adjustment in increments of fifteen degrees, there are twenty-four notches 136. For example, where it is desired to provide angular adjustment in increments of twenty degrees, there are eighteen notches 136. For example, where it is desired to provide angular adjustment in increments of thirty degrees, there are twelve notches 136. For example, where it is desired to provide angular adjustment in increments of forty-five degrees, there are eight notches 136. Preferably, there are at least twenty notches 136 to provide angular pattern insert adjustment in angular increments of no greater than 1-2 degrees. Preferably, there are a like number of detents 134.

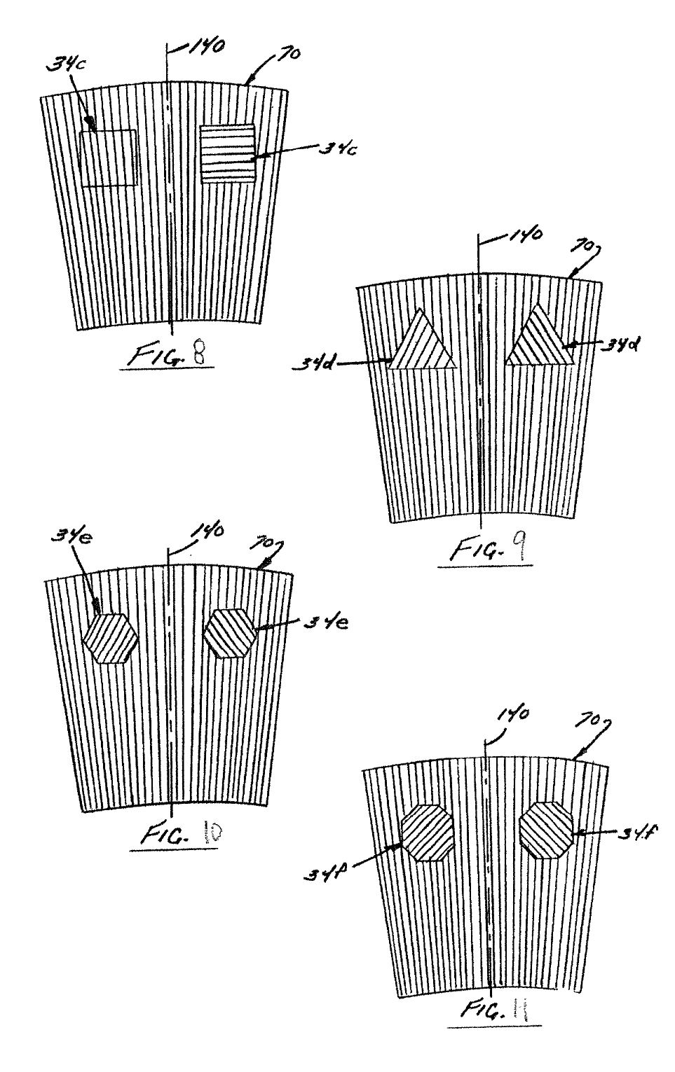

FIG. 8 depicts two circumferentially spaced apart pattern inserts 34c that are each square in shape. Each pattern insert 34c can be indexed in 90° increments. As a result, the pattern insert 34c can be indexed such that it is parallel to radial 140 or perpendicular to the radial 140.

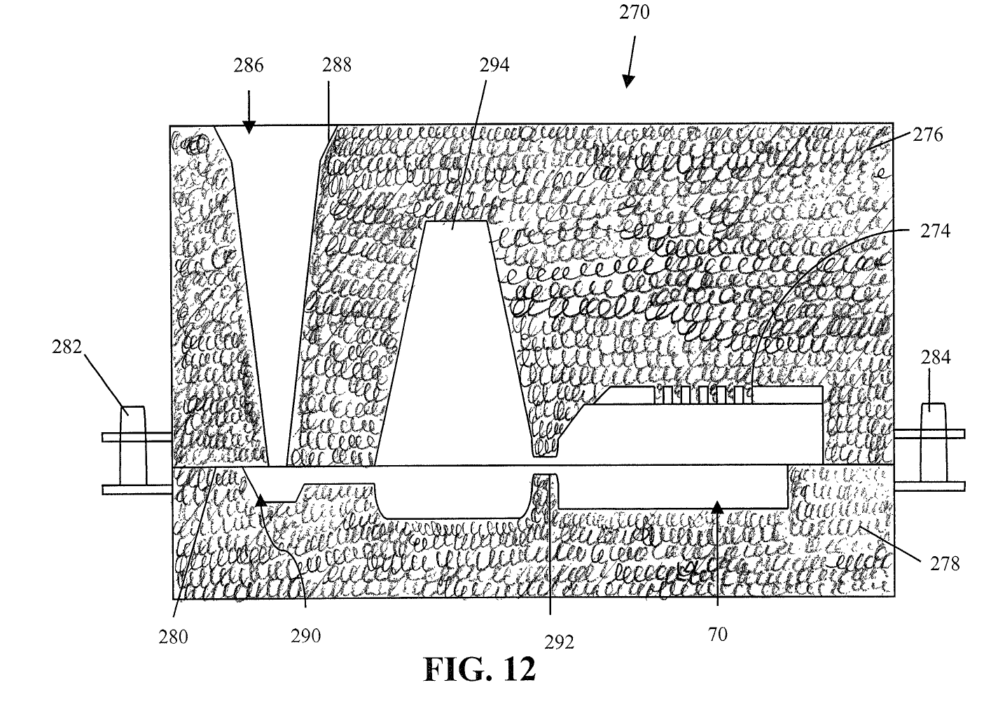

FIG. 9 depicts a pair of triangular pattern inserts 34d that each can be indexed in 120° increments. Each pattern insert 34d depicted in FIG. 12 is an equilateral triangle but can be a different type of triangle.

FIG. 10 depicts a pair of hexagonal pattern inserts 34e that each can be indexed in 90° increments. FIG. 11 depicts a pair of octagonal pattern inserts 34f that each can be indexed in 45° increments. If desired, pattern inserts having five, seven, nine, ten, eleven, twelve, or more sides can be used. If desired, the pattern inserts 34 can be constructed with a number of sides suitable to vary the increment of bar angle anywhere from 5° to 45° or more.

The refiner plate pattern can be used to make refiner plate segments 370 using any process where the refiner plate pattern 70 is used to make a mold cavity 274 from which the refiner plate segment is constructed. For example, a mold cavity 274 having a shape that is complementary to the shape of the refiner plate pattern can be formed. The mold cavity 274 can be filled with, for example, plastic pellets, and then heat can be applied to melt the plastic and to form a refiner plate having substantially the same shape as that of the refiner plate mold.

In a preferred use of the refiner plate pattern, the pattern is used in casting a refiner plate segment 370, as is illustrated in FIG. 12 and explained in detail below. Preferably, sand casting or investment casting is used. In a preferred embodiment, a refiner plate pattern 70 is fabricated, such as the ones shown in FIGS. 2 and 3. The refiner plate pattern 70 has a pattern insert 34 that has a refining surface 84 that is comprised of a plurality of spaced apart refiner bars 86 forming an arrangement of refiner bars 86 that form a refining surface 84. The orientation of the arrangement of refiner bars 86 of the pattern insert 34 can be changed relative to other refiner bars 72 of the refining surface 36 of the refiner plate pattern 70. In one preferred embodiment, the pattern insert 34 is circular, has a plurality of pairs of refiner bars 86, can have one or more breaker bars 94, and can have one or more dams 90.

Although not shown in the figures, if a preferred embodiment, the refiner plate pattern 70 includes tapers, i.e., drafts, so that the pattern may be easily removed from the sand. In a preferred embodiment, drafts are not less than 1° or ⅛ of an inch per foot, with a minimum of approximately 1/16 of an inch on any surface.

The orientation of the arrangement of refiner bars 86 of the pattern insert 34 can be moved to a desired orientation to form a refiner plate pattern 70 having a desired orientation of the insert refiner bars 86. The refiner plate pattern 70 can then be used to make a mold cavity 274 from which a refiner plate segment 370 can be formed, such as by casting, as is shown in FIG. 12. In a preferred method of making a mold cavity, the molding material is packed around the refiner plate pattern 70. In another preferred embodiment, the refiner plate pattern 70 is pressed into the molding material, forming an impression, i.e., a mold cavity 274. A preferred molding material is sand. The refiner plate pattern 70 is then removed to produce the mold cavity 274 having a shape that is complementary to that of the refiner plate pattern 70. In a preferred embodiment, a new mold cavity 274 is prepared for each casting. In another preferred embodiment, the mold cavity 274 is a permanent mold cavity 274 that is made from a material that can be used for repeated castings.

In a preferred embodiment, the mold 270 is made in one part. For this, the face of the refiner plate pattern 70 having the upraised bars is urged into a molding material with enough force to form a mold cavity 274 having a complementary shape to the face of the refiner plate pattern 70. A material, such as a molten material, can then be placed or poured into the mold cavity 274 to form a refiner plate segment 370 that has a shape that is substantially the same as the shape of the mold cavity 274.

In another preferred embodiment, the mold 270 is made from two parts: an upper cope 276 and a lower drag 278, as is illustrated in FIG. 12. The cope 276 and the drag 278 are connected at a parting line 280 with two hinges 282, 284 disposed on opposite sides of the mold 270. Where a two-part mold 270 is used, it preferably includes a pouring cup 286 that initially receives a material. In a preferred embodiment, the material is a molten material, such as molten metal or plastic. In another preferred embodiment, the material is one, such as plastic pellets, that can form to the shape of the mold. After the mold is filled with the material, for example, heat is applied. The pouring cup 286 has an opening 288 that is disposed above the mold cavity 274. The opening 288 extends downwardly to a gating system 290, which is a network of horizontal channels 292 used to deliver molten material. A riser 294 is located before the mold cavity 274. The riser 294 is an extra void that is filled with molten material that can flow into the mold cavity 274 to compensate for shrinkage. The mold cavity 274 is located after the riser 294.

In a preferred method, molten material is poured into the mold cavity 274 at the pouring cup 286. Preferably, provision is made to permit escape of all air and other gases in the mold cavity 274 before the pouring and all air and other gases in the mold cavity 274 before the pouring and those generated from the action of the molten material entering the mold cavity 274. For example, although not shown, vents can be included in the mold 270. After all air and other gases exit the mold cavity 274, the molten material can then completely fill the mold cavity 274, producing a quality refiner plate segment 370 that is fully dense and free of defects.

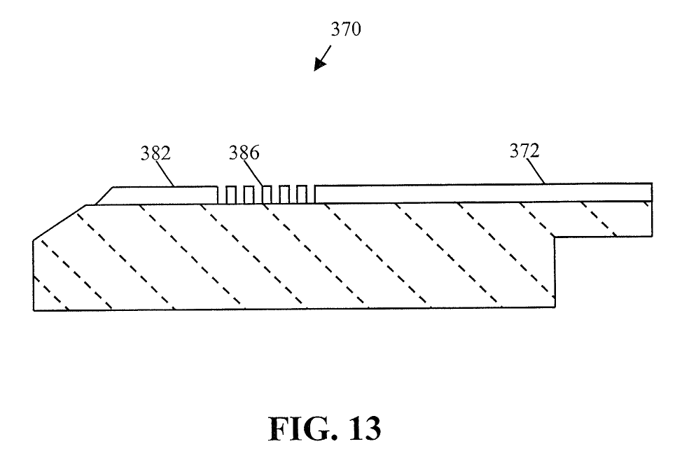

As is shown in the exemplary refiner plate segment 370 shown in FIG. 13, the refiner plate segment 370 includes upraised refiner bars 386 corresponding to the bars 86 on the pattern insert 34, upraised refiner bars 372 corresponding to the bars 72 on the refiner plate pattern 70, and upraised breaker bars 382 corresponding to the breaker bars 82 on the refiner plate pattern 70.

After the molten material solidifies, the mold 270 is removed from the cast refiner plate segment 370. After the cast refiner plate segment 370 is removed from the mold 270, various cleaning, finishing, and inspection processes may be performed. Any extraneous material that is attached where the metal entered the mold cavity 274, excess mold at the parting line 280, and mold material that is attached to the cast refiner plate segment 370 is removed.

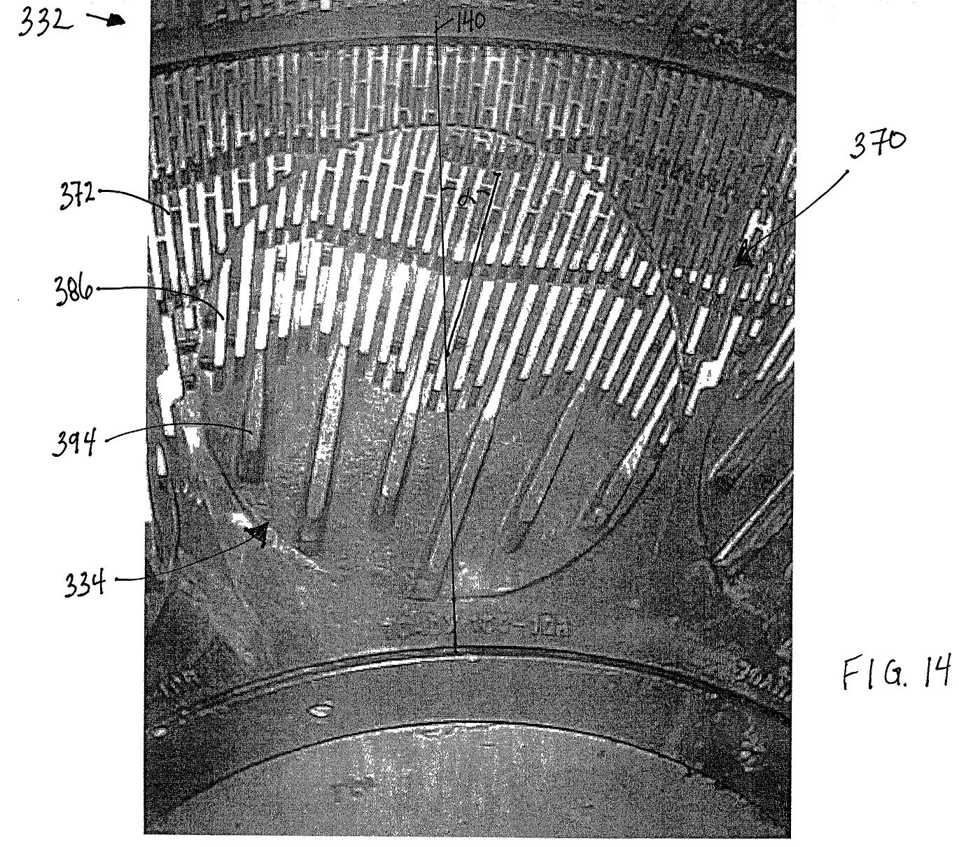

FIG. 14 illustrates a preferred embodiment of a refiner plate 332 made from refiner plate segments 370 cast in a refiner plate pattern 70 that includes breaker bars 94 on the pattern insert 34 and no breaker bars 82 on the refiner plate pattern 70. The resulting refiner plate segment 370 includes a portion of its refining surface 334 disposed adjacent its inner periphery angularly offset relative to another radially outwardly portion of its refining surface such that the angle of the refiner bars accelerates fibers adjacent the inner periphery.

By having such an angle offset, fibers enter the refiner plate more quickly and move to the portions having a greater refiner bar density where more refining can be done. By increasing fiber velocity adjacent the inner periphery, pressure is reduced where fiber enters the refiner plates and temperature is lowered. This advantageously diminishes fiber build up observed in previous plates. In previous plates fiber build up was caused by the slowed fibers accumulating, which led to the refiner pressure rising, which in turn generated heat. The heat increased the temperature of the fibers and produced steam. Steam obstructs the movement of fibers, thus, slowing down radial migration of the fibers. It is speculated that these effects led to more build up, producing an undesirable cycle of fibers accumulating and heat generating. Energy was also wasted in these non-productive processes. Furthermore, steam is undesirable because it removes the lignin that holds the fibers together, which can lead to the individual fibers separating. This makes paper production extremely difficult because the fibers will not grind and fibrillate properly.

In contrast, the refiner plate of this embodiment permits a lower fiber temperature upon entry onto the refiner plate. As the fibers move radially outwardly, the fiber temperature gradually raises such that peak temperature in the refining zone occurs adjacent the radial outer periphery to maximize refining done while minimizing energy. Energy is minimized because the fiber is not blocked where it enters by the region of increased pressure adjacent the inner radial periphery.

The invention also provides the advantage of being able to make a refiner plate segment 370 from the adjustable refiner plate pattern 70, thereby permitting an infinite number of refiner plate segments 370 to be made. Refiner plate segments 370 made from adjustable refiner plate patterns 70 have a high degree of variability that allows many different bar angles to be produced and to be tested to optimize refiner conditions.

Making a refiner plate segment 370 from a mold cavity formed from the refiner plate pattern 70 produces a segment 370 of unitary construction, with no moving parts. This prevents dislodgement of parts as can happen when parts are not of unitary construction. It also eliminates variability, e.g., in strength and durability, amongst materials of the segment. Segments 370 can be made quickly and at an economical cost. The refiner plate segments 370 can be assembled into a refiner plate 32 for a refiner disk 30.

In use, the refiner plate 32 formed of refiner plate segments 370 made from the refiner plate pattern 70 of this invention is used to refine fibrous matter in liquid stock. During refining, fiber in the stock that is introduced between opposed refiner plates 32 is refined by being ground, abraded, or mashed between opposed bars 72 of the plates 32 thereby fibrillating the fibers. Stock in the grooves 74 and elsewhere in the refining zone between the plates 32 flows radially outwardly and can be urged in an axial direction by dams to further encourage refining of the fiber. Depending on the construction, arrangement, and arrangement of the bars 72 and grooves 74, differences in angle between the bars 72 of opposed plates due to relative movement between the plates can repeatedly occur during operation. Where and when such differences in angle occur, radial outward flow of stock between the opposed plates can be accelerated, pumping the stock radially outwardly. Where and when the bars 72 and grooves 74 of the opposed plates are generally aligned, flow can be retarded or held back.

During operation, a fibrous stock slurry enters the refiner 30 through its inlet 42. The stock travels along auger 40 and shaft 44 to the flinger nut 50. The stock impinges radially outwardly off the flinger nut 50 toward a set of breaker bar segments 52 and further radially outwardly on to at least one set refiner plates 56 and 58 that is equipped with refiner plate segments 370 cast from the adjustable refiner plate pattern 70.

As the stock passes between the bars of opposed sets of refiner plates, fibrous matter in the stock is broken apart, split, sheared, and otherwise fibrillated to prepare it for subsequent fiber product processing. Processed stock is discharged from the refiner 30 after it has passed between the plates.

Where the refiner plate 32 is formed from refiner plate segments made from a refiner plate pattern 70 equipped with one or more movable pattern inserts 34, the position of the pattern insert 34, and hence the angle of the bars 86 of the pattern insert 34, is set before refiner plate segment 370 is made. After the position of each pattern insert 34 is set, the pattern insert 34 is fixed such that the angular position of the pattern insert bars 86 relative to the rest of the bars 72 of the refiner plate pattern 70 will not change during the formation of the refiner plate segments, i.e., the pattern insert 34 preferably will not rotate.

An infinite number of refiner plate segments 370 can be cast from the adjustable refiner plate pattern 70. This permits determination of a desired angle arrangement of the upraised bars 386,372, and 382 on the refiner plate segment 370 such that, for example, energy use is reduced. It also allows for determination of more preferred refiner bar angles to use for specific refiners and for specific conditions encountered at the refiner site. At a refiner testing site, an operator can use refiner plate segments 370 made from the adjustable refiner plate pattern 70 to empirically determine the refiner bar angle that are better than others by testing refiner plates, e.g., 32 assembled from the refiner plate segments 370 made from refiner plate patterns 70 having adjustable upraised bar angles.

In a preferred method of testing the refiner plates, a macro adjustment is made to the angle of the upraised bars of the pattern insert 34 relative to the remainder of the refiner plate pattern 70. A mold cavity 274 is created from the refiner plate pattern 70, and refiner plate segments 370 are formed therefrom. The refiner plate segments 370 are assembled into a first set of refiner plates, which are run in a refiner 30. From this run, it can be determined which refiner bar angles have desired characteristics, e.g., using a lesser amount of energy when compared to others. The refiner bar angles can be further tuned via a micro adjustment to the angle of the refiner bars.

For example, in the macro adjustment, a set of refiner plates, e.g., 32, is made with each plate being formed from refiner plate segments 370 made with different refiner bar angles formed of refiner plate segments 370 made by adjusting the pattern insert 34 in the refiner plate pattern 70. In a preferred embodiment, a set of different refiner plates 32, that differ preferably by 3° to 15°, and more preferably by 5° are tested. The set of different refiner plates 32 having the appropriate bar angles can be made with the adjustable refiner plate pattern 70 by turning the pattern insert 34 to form the angles, setting the angle, forming a mold cavity 274, and pouring the material into the pouring cup 286 and through the mold 270 to generate a set of refiner plate segments 370. The mold pattern segments 370 can then be assembled to generate the set of test plates 32. The test plates 32 can be run in the refiner 30 to generate data for each of the refiner plates 32. After running each of the plates 32 and collecting data therefrom, it might be determined that, for example, the fourth and fifth refiner plates, which have 30° and 35° angles, respectively, produce the desired results when compared to the other plates 32.

If desired, a micro adjustment can then be run to further determine which bar angles produce results that are even more desired. For this, another set of test plates 32 is made with refiner bar angles that differ by a finer increment, e.g., from 0.5° up to the greater increment of the first set of plates, or more. For example, plates having 30.0°, 30.5°, 31.0° bar angles can be made. This set of refiner plates 32 can be made as the initial plates were made, but with 0.5° increments in the bar angles. The new set of test plates 32 with 0.5° increments can then be assembled into refiner plates 32, and the refiner plates 32 can be tested to generate data for each of the new refiner plates 32. From this test run, the refiner bar angle that performs in a desired manner, e.g., uses the least amount of energy can be determined with a great degree of specificity.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

What is claimed is:

1. An adjustable refiner plate pattern for making a refiner plate segment for a refiner plate comprising:
a refiner plate pattern having upraised bars thereon and a portion of its refining surface having upraised bars thereon that is movable relative to another portion of its refining surface.

2. The adjustable refiner plate pattern of claim 1 wherein the movable portion of the refining surface is movable relative to the another portion of the refining surface such that the angle of the upraised bars of the movable portion of the refining surface relative to the angle of upraised bars of the another portion of the refining surface is changeable.

3. The adjustable refiner plate pattern of claim 2 wherein the movable portion of the refining comprises upraised breaker bars.

4. The adjustable refiner plate pattern of claim 1 wherein the orientation of its refining surface of the movable portion can be changed relative to the refining surface of the another portion.

5. The adjustable refiner plate pattern of claim 1 wherein the one portion of the refining surface is comprised of a pattern insert that has a plurality of upraised refiner bars.

6. The adjustable refiner plate pattern of claim 5 wherein the pattern insert is circular and can be turned to change the angle of the plurality of the upraised refiner bars of the pattern insert relative to the plurality of refiner bars of the another portion of the refining surface.

7. The adjustable refiner plate pattern of claim 5 wherein the pattern insert comprises an indexable pattern insert.

8. The adjustable refiner plate pattern of claim 7 wherein the indexable pattern insert is shaped like a square, an equilateral triangle, a pentagon, or an octagon.

9. The adjustable refiner plate pattern of claim 7 wherein the indexable pattern insert includes a number of sides suitable to vary the increment of bar angle anywhere from 5° to 45°.

10. The adjustable refiner plate pattern of claim 5 wherein the one of the refiner plates has a pocket that defines a window in the another portion of its refining surface and wherein the pattern insert is received in the pocket and the refining surface of the one portion of the refining surface is defined by the refiner bars of the pattern insert.

11. The adjustable refiner plate pattern of claim 11 wherein one of the pattern insert and the one of the refiner plates has a detent and the other one of the pattern insert and the one of the refiner plates has a plurality of spaced apart detent notches that is each capable of receiving a detent when the pattern insert is received in the pocket and permits the pattern insert to be indexed.

12. The adjustable refiner plate pattern of claim 1 wherein the one portion of the refining surface is comprised of a pattern insert that has a plurality of upraised refiner bars and a plurality of breaker bars.

13. The adjustable refiner plate pattern of claim 1 wherein the one portion of the refining surface is comprised of a pattern insert that is captured by a plate.

14. An adjustable refiner plate pattern for making a refiner plate segment for a refiner plate comprising:
a pattern including a refining surface that has a plurality of pairs of refiner bars extending outwardly therefrom and a pocket that defines a window in the refining surface;
a pattern insert received in the pocket, the pattern insert having a refining surface with a plurality of refiner bars that are adjacent the refiner bars of the plate when the pattern insert is received in the pocket; and
wherein the pattern insert can be rotated relative to the plate to change the angle of the refiner bars of the pattern insert relative to the angle of the refiner bars of the plate.

15. The adjustable refiner plate pattern of claim 14 wherein the pattern insert is removably received in the pocket and the refiner bars of the pattern insert are substantially flush with the refiner bars of the plate.

16. The adjustable refiner plate pattern of claim 15 wherein the plate is comprised of segments and each segment has a pocket with a pattern insert disposed in the pocket.

17. The adjustable refiner plate pattern of claim 14 wherein the pattern insert has a patterned surface that is uninterrupted by any fastener or other component used to attach the pattern insert to the pattern.

18. The adjustable refiner plate pattern of claim 17 wherein the outwardly extending portion extends about the periphery of the circular pattern insert.

19. The adjustable refiner plate pattern of claim 14 wherein the pattern insert is indexable.

20. The adjustable refiner plate pattern of claim 19 wherein the pocket is defined by a sidewall and one of the indexable pattern insert and the plate sidewall have a plurality of detents and the other one of the indexable pattern insert and the plate sidewall have a plurality of detent-receiving notches each of which is capable of receiving a detent.

21. The adjustable refiner plate pattern of claim 14 wherein the annular plate is comprised of a plurality of segments with one of the segments having a plurality of the pattern inserts.

22. A cast refiner plate segment for a refiner plate that has a arrangement of refiner bars that have offset bars and that are cast from a refiner plate pattern that has a portion of its refining surface that is movable relative to another portion of its refining surface.

23. A refiner plate comprised of a plurality of cast refiner plate segments that each are cast from a refiner plate pattern that has a portion of its refining surface that is movable relative to another portion of its refining surface.

24. The refiner plate of claim 23 wherein the region of the refining surface disposed radially outwardly from the angularly offset region has a bar angle relative to radial that is less than the angularly offset region.

25. The refiner plate of claim 23 wherein the angularly offset region has a refining surface comprised of upraised breaker bars.

26. The refiner plate of claim 25 wherein the region of the refining surface disposed radially outwardly of the angularly offset region has a refining surface comprised of upraised refiner bars.

27. The refiner plate of claim 26 wherein the angularly offset region has a refining surface comprised of upraised breaker bars and upraised refiner bars.

28. The refiner plate of claim 27 wherein the region of the refining surface disposed radially outwardly of the angularly offset region has a refining surface comprised of upraised refiner bars.

29. A refiner plate comprising an angularly offset region having an angle of at least 10 degrees relative to radial and being angularly offset relative to a region of the refining surface disposed radially outwardly of it.

30. The refiner plate of claim 29 wherein the angularly offset region has an angle of at least 20 degrees relative to radial.

31. A method of producing a refiner plate segment having a refining surface comprising a plurality of pairs of spaced apart and upraised bars using an adjustable refiner plate pattern, the method comprising:
(a) providing a refiner plate pattern that includes a portion of its refining surface pattern that is movable relative to another portion of its refining surface pattern;
(b) moving the portion of the refining surface pattern relative to the another portion of the refining surface pattern such that the angle of the refiner bars of the one portion of the refining surface pattern relative to the angle of refiner bars of the another portion of the refining surface pattern is changed to form an angle;
(c) setting the angle;
(d) forming a mold cavity from the pattern with the set angle; and
(e) making from the mold cavity a refiner plate segment having a refining surface that includes a plurality of pairs of spaced apart refiner bars with one portion of the refining surface having a first plurality of refining bars disposed at an angle relative to a second plurality of refining bars that is substantially the same as the angle set in step (c).

32. The method of claim 31 wherein the refiner plate segment is made by pouring a molten material into the mold cavity to form a cast of the pattern that is a refiner plate segment.

33. A method of producing a refiner plate segment having a refining surface comprising a plurality of pairs of spaced apart and upraised bars using an adjustable refiner plate pattern, the method comprising:
(a) providing a refiner plate pattern that includes a portion of its refining surface pattern that is movable relative to another portion of its refining surface pattern;
(b) moving the portion of the refining surface pattern relative to the another portion of the refining surface pattern such that the angle of the refiner bars of the one portion of the refining surface pattern relative to the angle of refiner bars of the another portion of the refining surface pattern is changed to form an angle;
(c) setting the angle;
(d) forming a mold cavity from the pattern with the set angle; and
(e) pouring a molten material into the mold cavity to form a cast of the pattern that is a refiner plate segment having a refining surface that includes a plurality of pairs of spaced apart refiner bars with one portion of the refining surface having a first plurality of refining bars disposed at an angle relative to a second plurality of refining bars that is substantially the same as the angle set in step (c).

34. A method of claim 31 further comprising:
(a) repeating step (e) to create enough refiner plate segments to form a refiner plate;
(b) forming a refiner plate from refiner plate segments; and
(c) running the assembled refiner plates in a refiner.

35. The method of claim 34 further comprising:
(a) collecting data from the refiner plate run in the refiner;
(b) comparing the data to data from another refiner plate; and
(c) determining which refiner plate has a desired characteristic.

36. The method of claim 35 further comprising:
(a) readjusting an angle of the upraised bars of the pattern insert relative to the upraised bars of the remainder of the refiner plate pattern to form a refiner plate pattern, wherein the angle being smaller than the angle in the first adjustment;
(b) creating a mold cavity from the refiner plate pattern having the readjusted angle;
(c) forming refiner plate segments from the mold cavity;
(d) assemblying the refiner plate segments from the refiner plate segments into a set of refiner plates; and
(e) running the assembled refiner plates in a refiner.

37. The method of claim 36 further comprising:
(a) collecting data from the refiner plate run in the refiner;
(b) comparing the data to data from another refiner plate; and
(c) determining which refiner plate has a desired characteristic.
